(19) United States
(12) Patent Application Publication
(10) Pub. No.: US 2010/0002963 A1
(43) Pub. Date: Jan. 7, 2010

(54) RECLOSABLE FOOD PACKAGE WITH IMPROVED SHELF LIFE

(76) Inventors: Victor Paul Holbert, Newbury, OH (US); Ronald F. Sieloff, Chardon, OH (US)

Correspondence Address: Avery Dennison Corporation;Amanda Wittine, 8080 Norton Parkway, 22-D, Mentor, OH, 44060, US

(21) Appl. No.: 12/166,071

(22) Filed: Jul. 1, 2008

(51) Int. Cl. B65D 33/16; B65D 33/18; B65D 33/00; B31B 49/04

(52) U.S. Cl. 383/204; 383/211; 383/207; 493/267

(57) ABSTRACT

A resealable container having an easily accessed yet airtight seal via the use of a tamper evident rupture strip which provides the container or package with improved shelf life for the product contained therein.

### FIELD OF THE INVENTION

The present invention relates to a resealable container having an easily accessed yet airtight seal via the use of a tamper evident rupture strip which provides the container or package with improved shelf life for the product contained therein.

### BACKGROUND OF THE INVENTION

Flexible containers for food products such as cookies and other snacks are well known. One normally gains access to the contents of a flexible pouch like container by opening one end of the pouch or wrapper. However, this process generally does not provide a convenient opening and reclosing arrangement. For example, reclosing of the wrapper, once opened, generally includes simply folding or rolling the end down and clipping the end to keep the wrapper closed.

Reclosable seals have been used for dispensing bags for wet tissues or disposable cleaning wipes. The labels on these bags can be pulled back, thereby exposing an opening, allowing access to the wet tissues or wipes inside. Typically, these dispensing bags are completely flexible, formed exclusively of a plastic or other suitable flexible material which closely surrounds the pack of wet tissues or wipes. Examples of these dispensing bags include U.S. Pat. Nos. 4,840,270 to Caputo and 6,026,953 to Nakamura, U.S. Design Pat. No. 447,054 to Hill and U.S. Patent Application Publication No. 2002/0182359 to Muir, all of which are incorporated by reference in their entirety.

In another prior dispensing bag for moistened tissues, shown in U.S. Pat. No. 6,428,867 to Scott, incorporated by reference in its entirety, tamper evidence is provided by use of a sealing label with an ink layer in the sealing area. Upon opening the bag, the label splits apart and leaves a residual ink indicia adhered to the sealing area to indicate the package has previously been opened.

In another prior dispensing bag, shown in U.S. Pat. No. 7,344,744 to Sierra-Gomez, incorporated by reference in its entirety, another means of rendering a resealable container tamper evident are shown. These include the use of tear able side strips and indicator tabs and friable ink indicators.

All of these prior methods rely on a perforation or scoring of the packaging material or a preformed opening to gain access to the container. In the case of perforations or score lines, these attributes allow the packaging material to separate from itself to create an access point to the container when the resealing device is opened. In a normal sealed container, the contents of the container are protected from exposure to materials outside the container by the elements that make up the walls of the container. Multilayer constructions are sometimes needed to prevent contamination of the contents by external environmental elements. However, when perforations or openings are added to the container, this becomes an easy entry point for contamination. In most resealable constructions, the adhesive system becomes the sealing mechanism for these perforations or openings. Adhesive systems, however, are not hermetic in nature and do allow transfer of gasses, moisture and low molecular weight chemicals over an extended period of time. In cases where the contents are not particularly sensitive to these types of contaminates, this does not present a problem. However, in cases where a long shelf life is required prior to use and/or the contents are particularly sensitive to these contaminants, these devices are not sufficient.

A need exists for a resealable container suitable which includes a tamper-evident indicator and provides an improved seal against contamination prior to consumption of the contents.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The purpose of the present invention is to provide a new and improved resealable container which provides adequate protection for the contents thereof, while concurrently facilitating opening of the container wrapper and resealing the seal to protect the contents thereof until the contents are fully consumed. The container may also include a tamper-evident indicator that indicates whether the container has been previously unsealed and provides a hermetic seal against contamination to afford improved shelf life prior to opening.

In one embodiment of this invention, a plastic film with a pressure sensitive adhesive layer adhered to one surface is attached to a side wall of an imperforate container via a heat seal or welding process. The adhesive layer is in contact with an outer surface of the container and the seal is hermetic in nature. This is done such that the imperforate opening in the container is situated within the perimeter of the sealing area with the seal being placed on a peripheral lip portion defined about the opening. A rupture line is built into the plastic film in an area interior to the primary attachment point, but exterior to the imperforate opening such that a portion of the adhesive remains sealably overlying the lip portion. To open the container, the hermetic seal is broken via severing of the rupture line and the resulting reclosable flap is lifted from the surface of the container which severs the perforations in the sidewall of the container and allows entry into the container. To reseal the container, the flap is lowered back on to the surface of the container. The reclosure may be further sealed with finger pressure applied to the perimeter of the resealable flap.

In another embodiment of this invention, a plastic film with a pressure sensitive adhesive layer is attached to the outer face of the rigid container via heat seal or welding process. The adhesive layer is in contact with the outer surface of the container. The plastic film covers the existing opening within the side wall of the container and the seal is placed on a peripheral lip portion defined about the opening. A tear strip is built into the plastic film in an area interior to the primary attachment point, but exterior to the opening, such that a portion of the adhesive remains sealably overlying the lip portion. To open this container, the hermetic seal is ruptured via removal of the tear strip and the reclosable flap is lifted from the surface of the container. To reseal the container, the flap is lowered back on to the surface of the container. The reclosure may be further sealed with finger pressure applied to the perimeter of the resealable flap.

In another embodiment, a plastic film with a cohesive layer is attached to the outer face of the imperforate container via heat seal or welding process. The cohesive layer of the film is in contact with the cohesive layer of the outer surface of the container. This is done such that the imperforate opening in the container is situated interior to the sealing area. A thin rupture strip is built into the plastic film in an area interior to the primary attachment point, but exterior to the imperforate opening. To open this container, the rupture strip is ruptured via applied stress to the rupture zone and the reclosable flap is lifted from the surface of the container. To reseal the container, the flap is lowered back on to the surface of the container. The reclosure may be further sealed with finger pressure applied to the perimeter of the resealable flap.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the exemplary embodiments of the invention in conjunction with the accompanying drawings, of which:

FIG. 1 is a perspective view of a container showing cut lines in the container and the lip portion surrounding the intended opening in the container;

FIG. 2 is a another perspective view of the one embodiment;

FIG. 3 is a top view of yet another embodiment where an adhesive free zone and a tab are added;

FIG. 4 is a top view of a future embodiment where an additional heat seal or weld is applied interior to the perforation;

FIG. 5 is a cross section of a tear strip;

FIG. 6 is a cross section view of one embodiment;

FIG. 7 is a flow diagram of an exemplary method of making of a resealable container; and

FIG. 8 is a flow diagram of another exemplary method of making of a resealable container.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

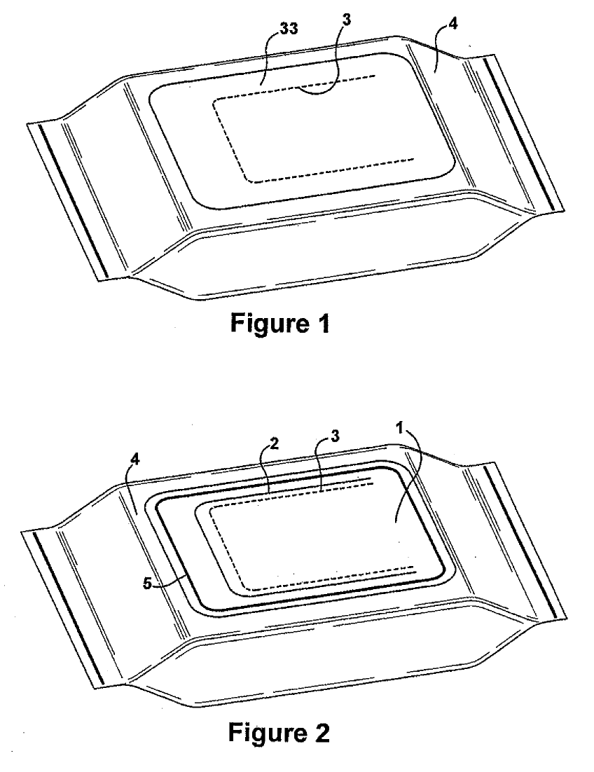

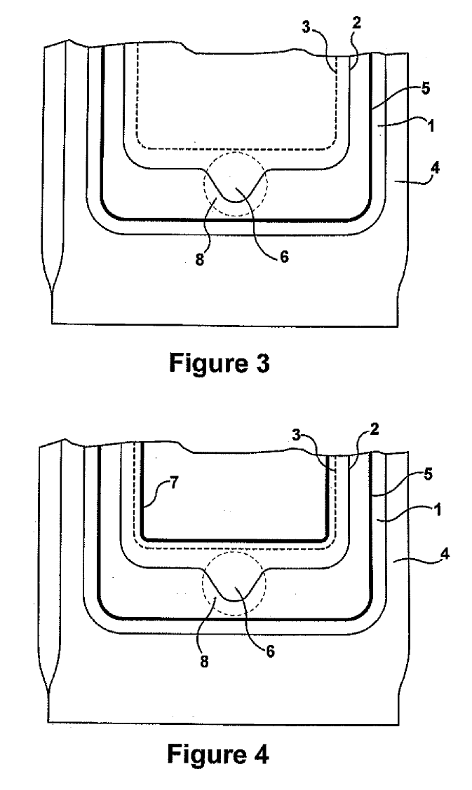

Referring to FIGS. 1-6, a flexible container 4 is represented as a sealed pouch, normally made of thin films of thermoplastic material or paper or foil or combination thereof, which is intended to contain materials such as food or chemicals. The pouch is typically formed by sealing one end of a tube like structure, filled with the desired contents and then sealed at the residual opening via heat welding or gluing.

While not wishing to be bound by any particular theory or embodiment, monolithic films can be employed to provide the barrier properties which normally require the use of multilayer laminate structures. The inner structure of the laminate advantageously includes a sealant layer forming the inner surface of the laminate. The sealant layer can comprise a heat seal material such as polyethylene, polypropylene, ionomer resin such as SURLYN®, or the like, or a cold seal material. The heat seal or cold seal layer can comprise either a film or a coating. The inner structure advantageously also includes a barrier layer providing a barrier against the passage of moisture and/or oxygen. In some applications such as the packaging of moisture-sensitive products (e.g., cookies or similar products that tend to be degraded when exposed to the environment), it is important to provide a moisture barrier.

The barrier layer can comprise any of various polymer-based barrier materials including barrier polymer films such as ethylene vinyl alcohol copolymer (EVOH), polyamide, and the like; metallized polyolefin films such as polyethylene, polypropylene, oriented polypropylene, and the like; AlOx-coated polymer films; SiOx-coated polymer films; metal foil such as aluminum foil; and others. Although the term “barrier layer” is used in connection with metallized films to refer to the entire metallized film, it will be recognized that it is the layer of metal that provides the barrier function. Likewise, it is the AlOx or SiOx coating that provides the barrier function in the ceramic-coated films, but the entire film nevertheless is referred to herein as a “barrier layer”.

The outer structure advantageously includes a layer of polyester such as polyethylene terephthalate, which has a desirable crisp feel and is readily printable. The polyester layer can be printed or imaged with inks or toner to provide graphics and indicia. In some embodiments, the polyester layer is transparent and is reverse-printed on the surface that faces the inner structure. Likewise, it is understood that rigid mono or multilayer containers can also be manufactured using similar constructions. Multilayer bottles for catsup are one example of such constructions.

The pouch structures of this invention can be prepared from sheets of material which are folded upon themselves in any number of configurations. Seams are typically glued or welded together using methods such as ultrasonic energy, heat or thermosetting materials. Likewise the pouches can be constructed from cylindrical tubes of material. These tubes, for example, can be prepared using a circular extrusion die with air introduced internal to the tube in order to prevent collapse of the tube prior to cooling of the film. These “blown films” are well known in the industry. By collapsing the tube to a flat structure, cutting to suitable length and by sealing the open end, a pouch can be constructed. Examples of blown films include EP 1111B1 to Pannenbecker and U.S. Pat. No. 4,354,997 to Mizutani, all of which are incorporated by reference in their entirety.

During the manufacture of the pouch like structure, perforations or cut lines 3 are placed into the film in such a way as to outline the desired area for use as an entry point into the sealed container. These perforations or cut lines can extend from the inner surface of the structure to the outer surface of the structure or they may only penetrate part way into the structure from either surface. These perforations or cut lines do not encompass the entire outline of the entry point such that upon rupturing the perforation or cut line, some portion of the resultant flap like structure remains affixed to the container. Surrounding this outline is a lip area 33. When the film is formed into a pouch, these cut lines outline an intended dispensing opening in a sidewall of container.

Atop this intended dispensing opening, a plastic film 1 with a pressure sensitive adhesive layer is hermetically attached to an outer surface of the imperforate container via a heat seal or ultrasonic welding process wherein the adhesive layer is in contact with the outer surface of the container 4. The film is sized and positioned so that the heat seal or weld line 5 completely encircles the lip area 33 and the cut lines 3. A rupture line 2 is built into the plastic film so that it overlies the lip area 33 and is sufficiently distant from the dispensing opening that a portion of the pressure sensitive adhesive layer remains sealably overlayed to the lip portion after activation of the rupture line 2. The rupture line does not have to completely encircle the dispensing opening, but rather only needs to be of sufficient length and location such that upon severing of the rupture line, a flap of suitable size to permit removal of the contents of the container is formed. To open this container, the hermetic seal is first broken via mechanical activation of the rupture line 2 and then a reclosable flap is formed by lifting the film from the surface of the container 4 and rupturing the cut lines 3. The adhesive should ideally be of sufficient strength such that the surface within the imperforate area remains fixably attached to the film and allows the rupture of the imperforations yet is adhesively detachable from the lip area. In some cases an additional heat seal or weld 7 is provided interior to the perforation to ensure that the area within the perforations remains fixably attached to the film. To reseal the container, the flap is lowered back on to the lip area 33 of the container. The reclosure may be further sealed with finger pressure applied to the perimeter of the resealable flap.

The plastic film 1 with sealing layer of this invention can be clear such as to not obstruct the observation of the graphics design of the container 4. Alternately, the plastic film 1 can be opaque and either printed to match the container graphics or can remain undecorated. The film 1 can be made out of the same material as the container or it can be of different construction as long as the desired barrier properties are maintained.

In the embodiment illustrated, a pressure-sensitive adhesive is used as the sealing layer. This pressure-sensitive adhesive can comprise various compositions. Pressure-sensitive adhesives form viscoelastic bonds that are aggressively and permanently tacky, adhere without the need of more than a finger or hand pressure, and require no activation by water, solvent or heat. Pressure-sensitive adhesives are often based on non-crosslinked rubber adhesives in a latex emulsion or solvent-borne form, or can comprise acrylic and methacrylate adhesives, styrene copolymers (SIS/SBS), and silicones. Acrylic adhesives are known for excellent environmental resistance and fast-setting time when compared with other resin systems. Acrylic pressure-sensitive adhesives often use an acrylate system. Natural rubber, synthetic rubber or elastomer sealants and adhesives can be based on a variety of systems such as silicone, polyurethane, chloroprene, butyl, polybutadiene, isoprene, or neoprene. When the packaging laminate of the invention is to be used for food packaging, the pressure-sensitive adhesive generally must be a food-grade composition. Various pressure-sensitive adhesives are approved by the U.S. Food and Drug Administration for use in indirect food contact, as regulated by 21 CFR Part 175.105; or may be self certified as GRAS (Generally recognized as safe).

One example of a food-grade pressure-sensitive adhesive is manufactured by Fasson identified by Product No. R 3400. An exemplary adhesive coat weight which might provide desirable peel force and resealing frequency is an adhesive coat weight of 3 pounds per ream of material. The R 3400 adhesive applied with the aforementioned coat weight provides for a resealing frequency, i.e., opening and resealing of the container 4 of at least 25 times.

The adhesives should also provide a desired peel force which is light enough to allow a consumer to easily peel back sealing film 1 while strong enough that a consumer is confident about the functionality of the container 4. Advantageously, the peel force between the film 1 and container 4 should be in the range of 200 to 750 grams per inch when measured on a 1 inch strip using the ASTM standard for measuring peel strength. Further, it is desirable for the adhesive to be relatively quiet upon separating the film 1 from the container 4 and that the adhesive not have an undesirable or offensive odor for consumers or impart any unsuitable properties to the food product contained inside the container 4. Likewise, the adhesive should demonstrate good barrier properties suited for the application. For moisture sensitive applications a moisture vapor barrier transmission rate of less than 0.01 g/square inch/day is desirable for application. These tests can be performed using a Honeymoon Model W 825 Water Vapor Transmission Rate Tester (Honeywell, Inc., Minneapolis, Minn.).

In applications where oxygen sensitivity of the product is an issue, a low oxygen transmission rate (OTR) adhesive can be employed. Preferably, the adhesive layer has an oxygen permeability rate of less than about 10 cc/100 in (645 cm2)/24 hr/atm at 100° F. (38° C.), more preferably, less than about 1.0 cc/100 in (645 cm2)/24 hr atm at 100° F. (38° C.). The aforesaid oxygen transmission rates can be determined by various methods known in the art. For example, these rates can conveniently be measured with a Dohrmann Polymeric Permeation Analyzer, PPA-1 (Dohrmann Envirotech Corporation, Mountain View, Calif.). The Dow Cell can also be employed for this purpose, in accordance with ASTM procedure D-1434.

In another embodiment, the sealing layer of choice is a cohesive system. These are fully described in US Patent Application 2005/0031233 to Varanese which is incorporated herein in its entirety. In this case the outer layer of the container 4 is constructed of a suitable material to cohesively interact with the sealing layer on film 1.

In one embodiment, a rigid container of fixed shape and volume is employed. During the manufacture of the rigid container, perforations or cut lines can be placed into the sidewall of the container. Alternately, an opening sufficient to remove the intended contents of the container can be designed into the structure.

In one embodiment, a non-sealing area is provided via construction of an adhesive or cohesive free zone. The adhesive or cohesive free zone, upon removal of the tear strip 2 affords the user an easily gripped area or tab 6 for assisting in opening the container.

In another embodiment, an ink is printed on the surface of the sealing layer of film 1 to create a non-sealing area. The non-sealing area, upon removal of the tear strip 2 affords the user an easily gripped area or tab 6 for assisting in opening the container.

In another embodiment, a heat seal or ultrasonic weld line 7 is also placed interior to the perforation 3 so as to permanently affix the area interior to the perforations to the film 1.

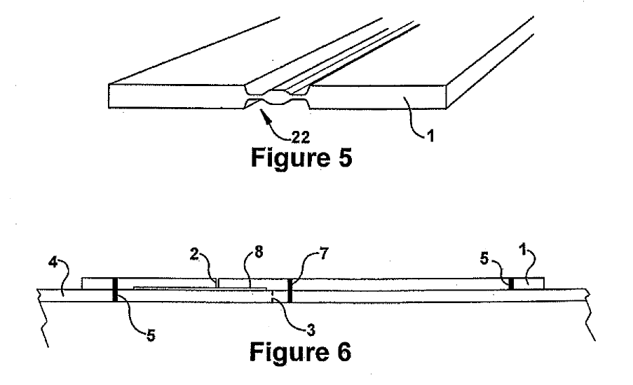

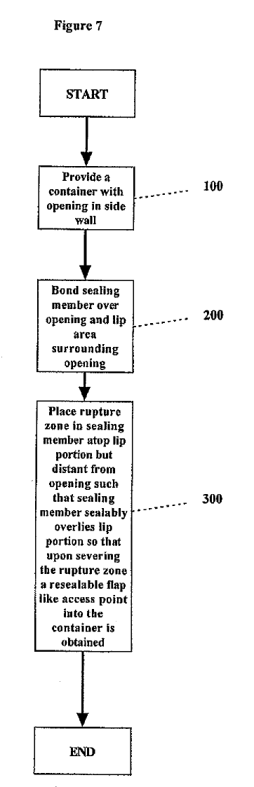

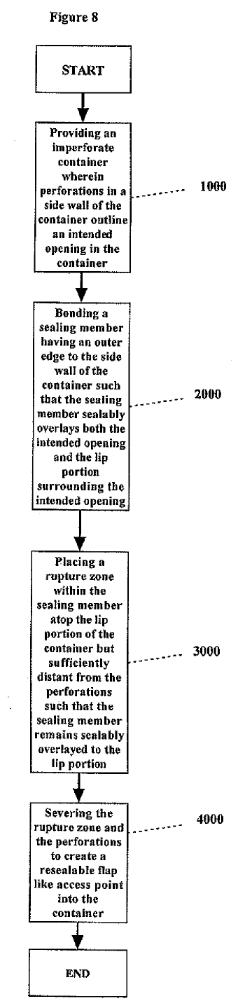

Rupture line constructions are well known in the art. Once such device could be a tear strip. Tear strips for this invention should be such that they are not imperforate in nature so as not to allow gas transmission. In one embodiment, (FIG. 5) this tear strip is a bead like structure 22 with thin areas to allow controlled tearing and large enough bead to allow ease of gripping and to give the device sufficient mechanical strength to be removed from the container 4 in one piece. Other rupture line constructions other than a tear strip could be employed. Prethinned areas within the film, for example, can act as easily ruptured devices which can be opened by applying localized stress to that area.

It will thus be seen according to the present invention a highly advantageous recloseable container has been provided. While the invention has been described in connection with what is presently considered to be the most practical embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1) An improved extended shelf life container having a built in opening and a reclose feature comprising;
a) a container body including a side wall having an opening for providing access to an interior portion of the container body and a peripheral lip portion defined about the opening;
b) a sealing member having an outer edge, the sealing member bonded to the side wall in close proximity to the outer edge and configured to sealably overlay the opening and the lip portion, the sealing member further including an outer fixed seal area and an inner portion covering the opening;
c) a rupture line within the sealing member located within the outer seal area such that the rupture line is located atop the lip portion but sufficiently distant from the opening that the sealing member remains sealably overlaid to the lip portion; and
wherein upon severing of the rupture line, a resealable hingedly connected flap is created for sealably opening and reclosing the container.

2) An article as recited in claim 1, wherein the sealing member comprises at least one film and at least one pressure sensitive adhesive disposed on one surface of the film.

3) An article as recited in claim 1, wherein the sealing member comprises at least one film and at least one cohesive bonding system, disposed on one surface of the film, that will sealably interact with the exterior surface of the container.

4) An article as recited in claim 1, wherein the container is a pouch.

5) An article as recited in claim 1, wherein the sealing member is attached to the sidewall of the container by a continuous perimeter of heat sealing.

6) An article as recited in claim 1, wherein the sealing member is attached to the sidewall of the container by a continuous perimeter of ultrasonic welding.

7) An article as recited in claim 1, wherein the container body has a fixed shape and volume.

8) An article as recited in claim 1, wherein the container body has a variable shape and volume.

9) An article as recited in claim 1, wherein the rupture line is a tear strip.

10) An article as recited in claim 2, wherein the adhesive has a peel strength of 200-750 grams per inch using a 1 inch strip.

11) An article as recited in claim 2, wherein the adhesive has a peel strength of 350-600 grams per inch using a 1 inch strip.

12) An article as recited in claim 1, wherein the rupture line encircles only a portion of the opening.

13) An article as recited in claim 1, wherein a non-sealing area is found on the flap such that upon severing of the rupture line, a loose tab is formed to provide a handle or tab for opening the container.

14) An article as recited in claim 13, wherein the non-sealing area is created by a pattern of ink in a selected area of the sealing layer.

15) An improved extended shelf life container having a built in opening and a reclose feature comprising;
a. a container body with a set of perforations in a side wall that define an outline of an area for an opening for providing access to an interior portion of the container body and a peripheral lip portion defined about the area for the opening;
b. a sealing member having an outer edge, the sealing member bonded to the side wall in close proximity to the outer edge and configured to sealably overlay the area for the opening and the lip portion, the sealing member having an outer fixed seal area and an inner portion covering the intended opening;
c. a rupture line within the sealing member located within the outer seal area such that the rupture line is located atop the lip portion but sufficiently distant from the area for the opening such that the sealing member remains sealably overlaid to the lip portion; and
severing the rupture line within the sealing member and breaking the perforations to form a resealable hingedly connected flap for sealably opening and reclosing the container and providing access into the container.

16) An article as recited in claim 15, wherein an additional heat seal or weld is provided interior to the set of perforations.

17) A method of making an improved extended shelf life container having a built in opening and a reclose feature comprising the steps of:
providing a container with an opening in a side wall;
bonding a sealing member having an outer edge to the side wall of the container such that the sealing member sealably overlays the opening and a lip portion surrounding the opening;
placing a rupture zone within the sealing member atop the lip portion of the container but sufficiently distant from the opening in the container such that the sealing member remains sealably overlayed to the lip portion; and
severing the rupture zone to create a resealable hingedly connected flap for sealably opening and reclosing the container and providing access into the container.

18) A method of making an improved extended shelf life container having a opening and a reclose feature comprising the steps of:
providing an imperforate container wherein perforations in a side wall of the container outline an area for an opening in the container;
bonding a sealing member having an outer edge to the side wall of the container such that the sealing member sealably overlays both the area for an opening and the lip portion surrounding the area for the opening;
placing a rupture zone within the sealing member atop the lip portion of the container but sufficiently distant from the perforations such that the sealing member remains sealably overlayed to the lip portion; and
severing the rupture zone and the perforations to create a rescalable flap like access point into the container.
